(19) United States
(12) Patent Application Publication
(10) Pub. No.: US 2002/0052703 A1
(43) Pub. Date: May 2, 2002

(54) Automatic calibration system for scanner-scale

(76) Inventor: Nicolas N. Tabet, Eugene, OR (US)

Correspondence Address: LYON & LYON LLP, 633 WEST FIFTH STREET, SUITE 4700, LOS ANGELES, CA, 90071, US

(21) Appl. No.: 09/947,228

(22) Filed: Sep. 4, 2001

Related U.S. Application Data
(60) Provisional application No. 60/241,299, filed on Oct. 17, 2000.

(51) Int. Cl. G06F 19/00; G01G 23/01

(52) U.S. Cl. 702/101

(57) ABSTRACT

A system and method for calibrating a scale portion of a scanner in a Point Of Sale (POS) system. In one method, a scanner-scale has its scale calibrated for a given target location by the steps of (a) performing an initial scale calibration during assembly; (b) providing the scanner-scale with a memory containing scale calibration data corresponding to a plurality locations; (c) selecting one or more programming labels containing data corresponding to the target location for the scanner-scale; (d) inputting the target location into the scanner-scale by scanning the one or more programming labels; (e) obtaining from the memory specific calibration data corresponding to the target location; and (f) calibrating the scale according to the specific calibration data obtained. Alternately, the system may use a GPS device to ascertain its location and then use that location information to provide for the auto-calibration.

This application claims priority to provisional application Serial No. 60/241,299 filed Oct. 17, 2000.

### BACKGROUND OF THE INVENTION

The field of the present invention relates to systems and methods for scale calibration of a data reading system. A typical data reading system is an optical scanner having an integrated scale (e.g. a scanner-scale). Scale calibration sets the scale to an accurate reference point for weighing. Scale calibration is a time-consuming procedure that is typically governed by governmental weights and measures statutes. Current scanner-scale products require customers to use a weight set to calibrate the scanner after installation. In addition, these scanner-scale products often need official registration and labeling by weights and measures officials to certify that the scale may be used for commerce.

The present inventor has recognized the desirability to eliminate the required on site calibration of the scale portion of a scanner-scale product by local weights and measures authorities but nonetheless be in compliance with state or local weights and measures requirements and obtain the necessary certification. Factory certification would eliminate the need for customers to perform this additional calibration/certification step.

### SUMMARY OF THE INVENTION

The present invention is directed to a system and method for calibrating a scale, particularly a scanner-scale of a POS system. In a preferred method, a scanner-scale has its scale calibrated for a given location by the steps of (a) performing an initial calibration on the scanner-scale during assembly; (b) providing the scanner-scale with a memory containing scale calibration data corresponding to a plurality locations; (c) during installation at the target location, selecting one or more programming labels containing data corresponding to the target location for the scanner-scale; (d) inputting the target location into the scanner-scale by scanning the one or more programming labels; (e) obtaining from the memory specific calibration data corresponding to the current target location; and (f) calibrating the scale according to the specific calibration data obtained. Alternately in another embodiment, the system may use a GPS device to ascertain its current (target) location (replacing steps (c) and (d)) and then use that location information to provide for the auto-calibration (i.e. proceeding with steps (e) and (f)).

### BRIEF DESCRIPTION OF THE DRAWINGS

FIG. 1 is perspective a view of a scanner-scale embodying a preferred embodiment.

FIG. 2 is a perspective view of a scanner-scale according to another embodiment and illustrating method of operation.

### DESCRIPTION OF THE PREFERRED EMBODIMENTS

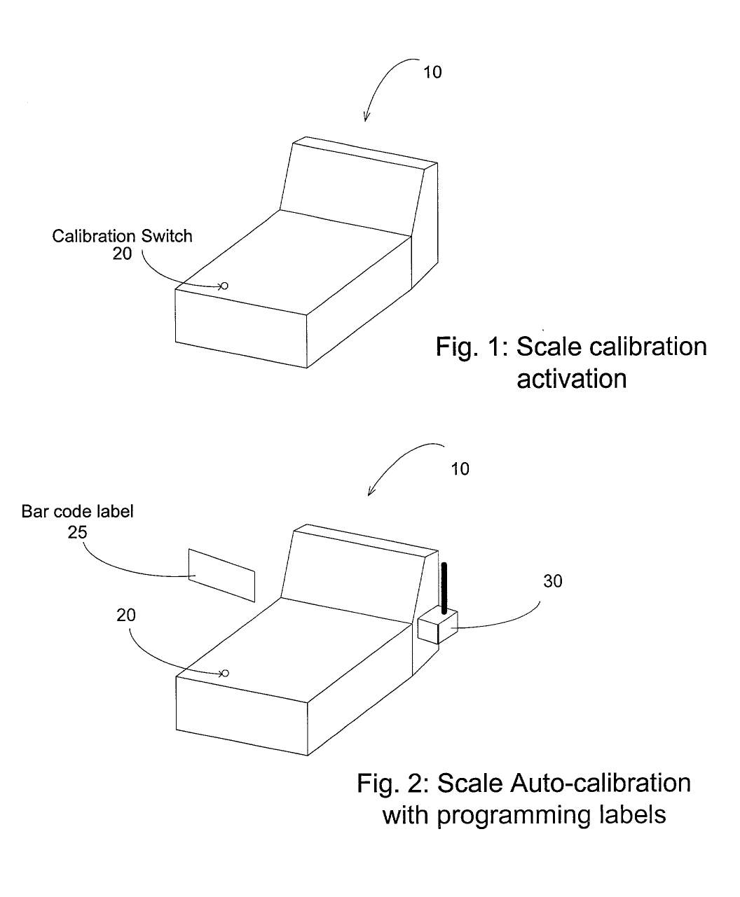

The preferred embodiments will now be described with reference to the drawings. FIG. 1 illustrates a scanner-scale 10 of a preferred configuration, such as the Magellan® scanner-scale available from PSC Inc. of Eugene, Oreg. The Magellan® scanner-scale is a multi-window scanner having a vertical window and a horizontal window. The horizontal window is integrated into the weigh platter. Alternately, the scanner-scale may comprise a single window scanner, the window being oriented either vertically or horizontally. The scale may have multiple weighing zones such as described in U.S. application Ser. No. 09/______ hereby incorporated by reference.

In a preferred system, the scanner-scale 10 is assembled and calibrated at the factory and shipped to any region without additional regional calibration. If a universal calibration is too costly, predefined calibration points based upon geography (elevation and/or magnetic pull based on latitude/longitude) could be pre-selected at the factory or selected by the consumer.

Eliminating calibration may result in reduced installation costs both at initial installation as well as when scanners are removed for repair. This reduced installation cost may result in lower cost of ownership for the customer by eliminating need to have someone certified by Weights and Measures to perform calibration.

Following is a list of several preferred methods for achieving re-calibration of the system.

Method 1: Scanner scale calibration mode is activated by steps of (a) entering the programming mode by either (i) activating a switch 20 as shown in FIG. 1 or (ii) soft switch via scanning a programming label; (b) once in programming scale calibration mode, scanning a first programming label 25 that contains data corresponding to the country code for the country the scale is being used (FIG. 2); (c) communicating to the scanner the region within the country by scanning a second programming label (or labels) that contains zip code or other suitable regional location data); (d) completing scale calibration by scanning the programming label (or actuating the switch 20) to exit and save the calibration parameters; (e) the scanner 10 then automatically setting the appropriate parameters (pre-stored and/or calculated) to calibrate the scale.

Method 2: Scanner-scale calibration mode is activated by means of (a) actuating a switch 20 as shown in FIG. 1 or (b) soft switch via scanning an “enter programming mode” label. Once the scanner-scale is placed in programming mode, a single label 25 containing country and region identification data is scanned to auto-calibrate the scale. An “exit programming mode” label is scanned or the switch is actuated to exit and save the calibration. The “enter” and “exit” labels may be the same or different labels.

Method 3: Scanner-scale calibration mode is activated by scanning a programming label as shown in FIG. 1. A single label or multiple labels that contain country and region identification numbers are scanned to auto-calibrate the scale. The programming label or switch is then used to exit and save the calibration.

Method 4: Auto-calibration is activated and completed via an interface to a PC, a POS terminal, or other device capable of communicating to the scanner. For example, the PC may contain in memory information corresponding to calibration data for the various locations where the scanner-scale may be located. The operator may input location into the PC via the keyboard, and the PC sends the calibration data to the scanner-scale, whereupon the scanner-scale calibrates. Alternately, the PC may obtain the calibration information for the particular location by connecting to the scale manufacturer's website and downloading the required data.

Method 5: Auto-calibration is activated via a switch or an “enter programming mode” label and completed with programming labels or with an external device communicating with the scanner via direct connection or wireless link.

Method 6: Upon calibration, the scanner provides visual and/or auditory means of indicating the acceptance or rejection of the auto-calibration.

Method 7: In the calibration modes, the “enter” and “exit” modes may be eliminated by utilizing one-step programming labels such as the Code 128 programming labels, whereupon scanning the specific scale calibration programming label provides the needed information to the scanner-scale to self calibrate.

Method 8: The scanner-scale may have appropriate parameters in memory and only require location parameter to enable self-calibration. Alternately, the programming labels may contain the calibration data for use by the scanner-scale to auto-calibrate the scale.

In any of the above methods utilizing programming labels, the scanner-scale 10 may be shipped with specific calibration bar code labels, such as attached to the cable or to the weigh platter. In the event the weigh platter is removable, bar code labels may be applied to the platter (e.g. on the underside), the scanner-scale placed in calibration mode, the platter removed and passed over the scan window to scan the labels thereby calibrating the scale. The correct labels may then be installed at the factory (or elsewhere). The labels may also be printed to include human-readable characters with the regional information.

The programming labels may be any suitable type of programming label such as modified from UPC, EAN or JAN; custom programming Code 39 labels; or programming labels made in accordance with the AIM 128 standard. Though each of these labels may comprise a standard 1-D bar code label, other types of symbologies or labels may be used such as 2-D; PDF-417; bar code labels with add-on codes; or RFID tags. The system may first require an “enter programming” label be scanned, and then additional labels containing the calibration or location data may be subsequently scanned.

In the event the scanner-scale is moved to a different location and different calibration data is required, replacement bar code labels containing the proper calibration data may be provided by one or more ways:

(1) operator manual—the operator manual may be provided with an appendix of bar codes corresponding to various regions, the user need only select and scan the appropriate bar code(s) corresponding to the current location of the scanner.

(2) call-request system—a user or technician may place a telephone call to a toll-free number and input a zip code (or a country code and regional code) and the system may fax, mail or email back to the user a set of one or more programming labels containing the appropriate calibration data.

(3) internet—an operator may log onto the scanner manufacturer's website where a suitable selection interface permits the user to either download, email or print out a set of one or more programming labels containing the appropriate calibration data. One example interface would be to display a graphical map, the user clicking on a particular portion of the map which prompts the display to progressively display a more detailed region until the specific location of the scanner is displayed whereupon the appropriate set of one or more programming labels containing the appropriate calibration data may be displayed for printing or emailed to the user.

The calibration labels may include the precise calibration data, or in the event the scanner-scale contains the calibration data in memory, the programming labels may merely comprise location data, for example a zip code. Upon knowing its location, the scanner-scale extracts from its own memory (or from the host memory, the POS terminal memory, the store computer memory or other) the proper calibration data for that location.

The scale calibration may be accomplished via even more automatic systems. For example, the scanner-scale may be provided with an auto-locate system, such as a Global Positioning System (GPS) 30 disposed on the scanner-scale 10 (shown in FIG. 2). At a suitable time (e.g. each time the scanner is powered up; upon actuation of a calibration switch; or upon reading a “calibrate now” programming label), the GPS accesses the satellite signals, calculates a location and provides location information to the scanner-scale. Upon knowing its location, the scanner-scale may then extract from its memory (or the store computer or some other source such as via an internet link) the proper scale calibration data for that location. The auto-calibration system calibrates the scale for the new location using the calibration data.

The scanner may also be equipped with RF communications capability that allows the scanner to communicate with local cellular telephone transmitters. By communication with the local cellular telephone network, the scanner can determine its location. Upon knowing its location, the auto-calibration system can calibrate the scanner-scale for the new location.

Though the present invention has been set forth in the form of its preferred embodiments, it is nevertheless intended that modifications to the disclosed systems and methods may be made without departing from inventive concepts set forth herein. The scope of the invention is thus not to be limited other than in the spirit of the following claims.

What is claimed is:

1. A method of calibrating the scale of a scanner-scale system, comprising the steps of
(a) switching the system into programming mode;
(b) once in programming mode, communicating location data to the scanner-scale by (i) scanning a first programming label containing data that corresponds to a country code and (ii) scanning a second programming label containing data that corresponds to a zip code or other suitable regional location data;
(c) the system using the location data to auto-calibrate the scale for the location;
(d) switching the system out of programming mode.

2. A method according to claim 1 wherein the step of switching the system into programming mode comprises scanning a programming label which instructs the system to enter the programming mode.

3. A method according to claim 1 wherein the step of switching the system into programming mode comprises actuating a mechanical switch on the scanner-scale.

4. A method according to claim 1 further comprising
storing in a memory calibration data corresponding to a plurality of locations.

5. A system with a self-calibrating scale, comprising
an integrated scanner-scale combination;
an internal calibration system contained within the scanner-scale, including
a memory containing scale calibration data corresponding to a plurality locations,
means for determining a current location of the scanner-scale,
means for obtaining from the memory the specific calibration data corresponding to the current location,
means for calibrating the scale according to the specific calibration data obtained.

6. A system according to claim 5 wherein scanner-scale is operative to determine current location by reading one or more programming labels containing location data.

7. A system according to claim 5 wherein the scanner-scale is operative to read a first label containing country code data and a second label containing regional location data.

8. A system according to claim 5 further comprising a GPS system for determining the current location.

9. A system according to claim 5 further comprising a connection to an external database or server for downloading specific calibration data into the memory.

10. A method for calibrating a scale of a scanner-scale combination for a given location, comprising the steps of
providing the scanner-scale with a memory containing scale calibration data corresponding to a plurality locations;
during installation at the target location, selecting one or more programming labels containing data corresponding to the target location for the scanner-scale;
inputting the target location into the scanner-scale by scanning the one or more programming labels;
obtaining from the memory specific calibration data corresponding to the target location;
calibrating the scale according to the specific calibration data obtained.

11. A method according to claim 10 further comprising
downloading calibration data for one or more locations into a memory in the scanner-scale.

12. A method according to claim 10 further comprising switching the system into programming mode by scanning a programming label which instructs the system to enter the programming mode.

13. A method according to claim 10 further comprising switching the system into programming mode actuating a mechanical switch on the scanner-scale.

14. A method according to claim 10 further comprising storing calibration information in non-volatile memory.

15. A method according to claim 10 further comprising
performing an initial calibration on the scale during assembly or manufacture.

16. A method for calibrating a scale of a scanner-scale combination for a given target location, comprising the steps of
inputting scale calibration data into the scanner-scale by the steps of selecting one or more programming labels containing scale calibration information corresponding to the target location of the scanner-scale, and scanning the one or more programming labels with the scanner; and
calibrating the scale according to the specific calibration data obtained.

17. A method according to claim 16 further comprising
performing an initial calibration on the scale during assembly or manufacture.
